(19) United States
(12) Patent Application Publication
(10) Pub. No.: US 2026/0212462 A1
(43) Pub. Date: Jul. 23, 2026

(54) IMAGE PROCESSING METHOD AND IMAGE PROCESSING APPARATUS

(71) Applicant: SHIMADZU CORPORATION, Kyoto-shi (JP)

(72) Inventor: Naoki MORIMOTO, Kyoto-shi (JP)

(73) Assignee: SHIMADZU CORPORATION, Kyoto-shi (JP)

(21) Appl. No.: 19/451,473

(22) Filed: Jan. 16, 2026

(30) Foreign Application Priority Data
Jan. 20, 2025 (JP) 2025-008053

(51) Int. Cl. G06T 5/70; G06T 5/20; G06V 10/74; G06V 10/75

(52) U.S. Cl. CPC G06T 5/70; G06T 5/20; G06T 2207/10081; G06T 2207/10116; G06T 2207/20008; G06V 10/759; G06V 10/761

(57) ABSTRACT

An image processing method comprises: a step of acquiring a similarity between a first region 41 including a target pixel 42 and a second region 43 including a neighboring pixel 44, the regions being included in a predetermined region 40; a step of acquiring a similarity index value as an index for evaluating a degree of abundance of the second region 43 similar to the first region 41, based on the acquired similarity; a step of adjusting a filter strength h such that the filter strength h, which indicates a degree of noise reduction in the predetermined region 40, decreases as the acquired similarity index value increases; and a step of performing a smoothing process on the image data 33 by smoothing the target pixel 42 based on the adjusted filter strength hₒₚₜ, using an adaptive Non-Local Means filter capable of varying the filter strength h for each predetermined region 40.

### TECHNICAL FIELD

The present invention relates to an image processing method and an image processing apparatus.

### BACKGROUND ART

Conventionally, image processing methods are known (see, for example, Patent Literature 1).

Patent Literature 1 discloses a technique using a Non-Local Means (NLM) filter as an image processing method for removing noise from an image. In the technique using the Non-Local Means filter, a luminance difference value is calculated in an arbitrary area within a frame, and an additional average intensity is set. Then, after weighting the pixel value of a pixel and the additional average value of peripheral pixels according to this additional average intensity, a weighted average value obtained by adding these is output as the processed image data.

### CITATION LIST

### Patent Literature

[Patent Literature 1] JP 2020-021314 A

### SUMMARY OF INVENTION

### Technical Problem

Although not explicitly stated in Patent Literature 1, in the smoothing process using the Non-Local Means filter, when a high-contrast image region and a low-contrast image region are mixed in the image data, the same smoothing process is performed in the high-contrast image region and the low-contrast image region. In the smoothing process, noise is reduced by blurring and smoothing the image. Therefore, in the image data after the smoothing process, even if the subject in the high-contrast image region exists in substantially the same manner as before the smoothing process, the subject in the low-contrast image region may be blurred or may have disappeared. Therefore, in the smoothing process of image data, it is desired to suppress blurring and disappearance of the subject in the low-contrast image region of the image data.

The present invention has been made to solve the above problems, and one object of the present invention is to provide an image processing method and an image processing apparatus capable of suppressing blurring and disappearance of a subject in a low-contrast image region of image data in a smoothing process of the image data.

### Solution to Problem

An image processing method comprising: a step of acquiring a similarity between a first region including a target pixel and a second region different from the first region including a neighboring pixel located in the vicinity of the target pixel, the regions being included in a predetermined region of image data; a step of acquiring a similarity index value as an index for evaluating a degree of abundance of the second region similar to the first region, based on the acquired similarity; a step of adjusting a filter strength such that the filter strength, which indicates a degree of noise reduction in the predetermined region, decreases as the acquired similarity index value increases; and a step of performing a smoothing process on the image data by smoothing the target pixel based on the adjusted filter strength, using an adaptive Non-Local Means filter capable of varying the filter strength for each predetermined region.

Also, an image processing apparatus comprising: an image data transceiver unit configured to transmit and receive image data; and an image processing unit, wherein the image processing unit acquires a similarity between a first region including a target pixel and a second region different from the first region including a neighboring pixel located in the vicinity of the target pixel, the regions being included in a predetermined region of the image data acquired by the image data transceiver unit, acquires a similarity index value as an index for evaluating a degree of abundance of the second region similar to the first region, based on the acquired similarity, adjusts a filter strength such that the filter strength, which indicates a degree of noise reduction in the predetermined region, decreases as the acquired similarity index value increases, and performs a smoothing process on the image data by smoothing the target pixel based on the adjusted filter strength, using an adaptive Non-Local Means filter capable of varying the filter strength for each predetermined region.

### Advantageous Effects of Invention

In the above image processing method, the filter strength is adjusted such that the filter strength of the predetermined region decreases as the acquired similarity index value increases. Here, when the acquired similarity index value is large, it may be that the predetermined region is a low-contrast image region because many second regions similar to the first region exist. Therefore, in the predetermined region which is a low-contrast image region with a large acquired similarity index value, the filter strength is adjusted to be small, and the target pixel is smoothed using the adaptive Non-Local Means filter based on the adjusted filter strength. Therefore, a different smoothing process can be performed for the high-contrast image region and the low-contrast image region. As a result, in the smoothing process of the image data, blurring and disappearance of the subject in the low-contrast image region of the image data can be suppressed.

Also, in the above image processing apparatus, the filter strength is adjusted such that the filter strength of the predetermined region decreases as the acquired similarity index value increases. Here, when the acquired similarity index value is large, it may be that the predetermined region is a low-contrast image region because many second regions similar to the first region exist. Therefore, in the predetermined region which is a low-contrast image region with a large acquired similarity index value, the filter strength is adjusted to be small, and the target pixel is smoothed using the adaptive Non-Local Means filter based on the adjusted filter strength. Therefore, a different smoothing process can be performed for the high-contrast image region and the low-contrast image region. As a result, it is possible to provide an image processing apparatus capable of suppressing blurring and disappearance of the subject in the low-contrast image region of the image data in the smoothing process of the image data.

### BRIEF DESCRIPTION OF DRAWINGS

FIG. 1 is a schematic diagram showing the overall configuration of an X-ray imaging apparatus according to an embodiment.

FIG. 2 is a diagram for explaining a first region and a second region within a predetermined region.

FIG. 3 is a graph for explaining the relationship between the negative correlation of Euclidean distance and weight value, and filter strength.

FIG. 4 is a graph of a function for adjusting the filter strength.

FIG. 5 is a diagram of simulated image data before a smoothing process.

FIG. 6 is simulated image data after a smoothing process using a conventional standard Non-Local Means filter.

FIG. 7 is simulated image data after a smoothing process using an adaptive Non-Local Means filter according to an embodiment.

FIG. 8 is simulated image data after a smoothing process using an adaptive Non-Local Means filter based on each of a plurality of adjusted filter strengths according to an embodiment.

FIG. 9 is a flowchart for explaining a smoothing process using an adaptive Non-Local Means filter by an image processing unit in an embodiment.

### DESCRIPTION OF EMBODIMENTS

Hereinafter, embodiments embodying the present invention will be described based on the drawings.

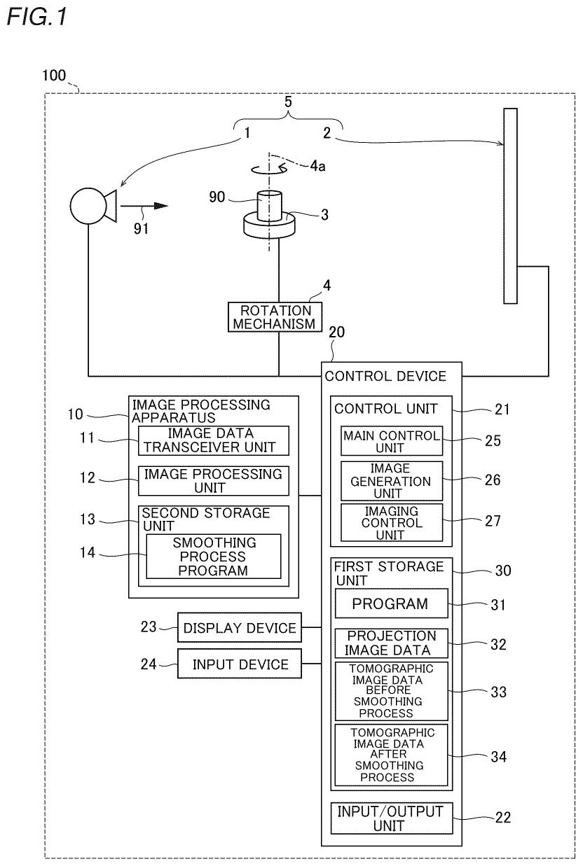

An image processing apparatus 10 according to the present embodiment is applied to, for example, an X-ray imaging apparatus 100, and performs image processing on tomographic image data 33 (CT image data) acquired by the X-ray imaging apparatus 100. The overall configuration of the X-ray imaging apparatus 100 will be described with reference to FIG. 1. The tomographic image data 33 is an example of “image data” in the claims.

### (Configuration of X-Ray Imaging Apparatus)

The X-ray imaging apparatus 100 is an apparatus that captures an X-ray image of a subject 90 and generates a CT image. The X-ray imaging apparatus 100 of the present embodiment is used for non-destructive inspection applications, for example. The subject 90 to be inspected is not particularly limited as long as it is an object other than a living body. The X-ray imaging apparatus 100 acquires projection image data 32 (X-ray image data) of the subject 90 from the entire circumference in the circumferential direction of the subject mounting unit 3 on which the subject 90 is placed, and constructs tomographic image data 33 based on the acquired projection image data 32.

The X-ray imaging apparatus 100 includes an X-ray tube 1, a detector 2, a subject mounting unit 3, a rotation mechanism 4, a control device 20, and an image processing apparatus 10. The X-ray tube 1 and the detector 2 constitute an imaging unit 5 that captures an X-ray image.

The X-ray tube 1 is configured to irradiate X-rays 91 onto the subject 90 placed on the subject mounting unit 3. The X-ray tube 1 is configured to generate X-rays 91 when a high voltage is applied. The X-ray tube 1 faces the detector 2 via the subject mounting unit 3. The X-ray tube 1, the subject mounting unit 3, and the detector 2 are arranged side by side in the horizontal direction.

The detector 2 is configured to detect the X-rays 91 emitted from the X-ray tube 1. The X-rays 91 emitted from the X-ray tube 1 pass through the subject 90 and enter the detection surface of the detector 2. The detector 2 is configured to convert the detected X-rays 91 into electrical signals. Thereby, an X-ray image reflecting the transmission of X-rays 91 in the subject 90 is obtained. The detector 2 is, for example, an FPD (Flat Panel Detector). The detector 2 outputs detection signals to the image generation unit 26.

The subject mounting unit 3 is arranged between the X-ray tube 1 and the detector 2, and is configured to mount the subject 90. The subject mounting unit 3 is constituted by a subject stage on which the subject 90 is placed.

The rotation mechanism 4 rotates one of the imaging unit 5 including the X-ray tube 1 and the detector 2, and the subject mounting unit 3. Thereby, the rotation mechanism 4 is configured to change the imaging angle of the subject 90. The rotation mechanism 4 rotates one of the imaging unit 5 and the subject mounting unit 3 around a rotation axis 4a. The rotation axis 4a is orthogonal to a straight line (a representative line of the X-ray flux) extending from the X-ray tube 1 through the subject 90 on the subject mounting unit 3 to the detector 2. The rotation axis 4a passes through the subject mounting unit 3 and extends along the vertical direction. In the present embodiment, the rotation mechanism 4 rotates the subject mounting unit 3 around the rotation axis 4a within a horizontal plane. The rotation mechanism 4 does not rotate the imaging unit 5. The rotation mechanism 4 includes a motor (not shown), a speed reducer (not shown), and the like for rotating the subject mounting unit 3.

The control device 20 includes a control unit 21, a first storage unit 30, and an input/output unit 22. The control device 20 is configured by, for example, a PC (Personal Computer). The control device 20 is connected to the image processing apparatus 10, a display device 23, and an input device 24.

The control unit 21 is a computer including a CPU (Central Processing Unit), a GPU (Graphics Processing Unit), a ROM (Read Only Memory), a RAM (Random Access Memory), and the like. The control unit 21 performs predetermined control by the CPU executing a predetermined program 31. The control unit 21 includes, as functional configurations, a main control unit 25, an image generation unit 26, and an imaging control unit 27. That is, the control unit 21 functions as the main control unit 25, the image generation unit 26, and the imaging control unit 27 by the CPU executing the predetermined program 31.

The main control unit 25 sets imaging conditions in the X-ray imaging apparatus 100 and controls the start and stop of imaging by executing the program 31 stored in the first storage unit 30.

The image generation unit 26 acquires a plurality of projection image data 32 at each of a plurality of imaging angles from the detector 2. The image generation unit 26 generates projection image data 32 from the acquired detection signals. By changing the imaging angle of the subject 90 by the rotation mechanism 4, an X-ray image of the subject 90 is captured by the imaging unit 5 at each of a plurality of preset imaging angles. The projection image data 32 is data of an X-ray image acquired for each imaging angle.

The image generation unit 26 is configured to generate CT image data based on the acquired plurality of projection image data 32. The image generation unit 26 generates CT image data by executing a reconstruction process on a set of projection image data 32 for each imaging angle over 360 degrees. The CT image data is an image reflecting the three-dimensional structure of the subject 90, and is reconstructed by arithmetic processing from X-ray images (projection image data 32) for each of a plurality of imaging angles. The CT image data is tomographic image data 33 of the subject 90. The image generation unit 26 outputs the tomographic image data 33 before the smoothing process to the image processing apparatus 10.

The imaging control unit 27 performs operation control of the X-ray tube 1 and operation control of the rotation mechanism 4. Specifically, the imaging control unit 27 performs control to irradiate X-rays 91 from the X-ray tube 1 for each of the plurality of imaging angles.

The first storage unit 30 is configured to include a volatile storage device and a non-volatile storage device. The first storage unit 30 stores a program 31, various setting information (not shown) related to X-ray image capturing of the X-ray imaging apparatus 100, and the like. The storage unit stores the acquired plurality of projection image data 32, the tomographic image data 33 before the smoothing process generated based on the projection image data 32, and the tomographic image data 34 (CT image data) after the smoothing process, which is obtained by subjecting the tomographic image data 33 before the smoothing process to the smoothing process by the image processing apparatus 10.

The input/output unit 22 is configured by various interfaces for inputting and outputting signals to and from the control device 20. The input/output unit 22 is connected to the display device 23 and the input device 24. The display device 23 is, for example, a liquid crystal display device or the like. The input device 24 includes a keyboard, a mouse, and the like. The image generation unit 26 acquires detection signals (image signals) from the detector 2 via the input/output unit 22. Further, the image generation unit 26 outputs the tomographic image data 33 before the smoothing process to the image processing apparatus 10 via the input/output unit 22.

The image processing apparatus 10 is configured to perform a smoothing process on the tomographic image data 33 by executing a smoothing process program 14. The image processing apparatus 10 is configured as dedicated hardware including, for example, a computer. Note that the image processing apparatus 10 may be configured by a CPU, GPU, ROM, RAM, and the like that are common to or separate from the control unit 21 of the control device 20. In that case, the image processing apparatus 10 is configured on software by causing the CPU to execute the smoothing process program 14. Note that the image processing apparatus 10 may be provided separately from the control device 20, or may be incorporated as part of the control unit 21 of the control device 20.

### (Configuration of Image Processing Apparatus)

The image processing apparatus 10 includes an image data transceiver unit 11, a second storage unit 13, and an image processing unit 12. The image processing apparatus 10 is connected to the control device 20.

The image data transceiver unit 11 is configured to acquire the tomographic image data 33 before the smoothing process from the first storage unit 30 via the input/output unit 22 of the image generation unit 26. Further, the image data transceiver unit 11 is configured to output the tomographic image data 34 after the smoothing process, which has been subjected to the smoothing process by the image processing unit 12, to the first storage unit 30 via the input/output unit 22 of the image generation unit 26.

The second storage unit 13 is configured to include a volatile storage device and a non-volatile storage device. The second storage unit 13 stores a smoothing process program 14 and the like for executing a smoothing process to smooth the tomographic image data 33.

The image processing unit 12 is configured as a computer including a processor such as a GPU (Graphics Processing Unit) or an FPGA (Field-Programmable Gate Array) configured for image processing. The image processing unit 12 executes a smoothing process to smooth the tomographic image data 33 by the processor executing the smoothing process program 14.

The image processing unit 12 acquires a similarity between a first region 41 including a target pixel 42 and a second region 43 different from the first region 41 including a neighboring pixel 44 located in the vicinity of the target pixel 42, the regions being included in a predetermined region 40 of the tomographic image data 33 acquired by the image data transceiver unit 11. Further, the image processing unit 12 acquires a similarity index value as an index for evaluating a degree of abundance of the second region 43 similar to the first region 41, based on the acquired similarity. Further, the image processing unit 12 performs a smoothing process on the tomographic image data 33 using an adaptive Non-Local Means filter capable of varying a filter strength h for each predetermined region 40.

Note that in this specification, the filter strength h means the degree of noise reduction, and the pixel is smoothed more as the filter strength h increases. Further, in this specification, the adaptive Non-Local Means filter means a Non-Local Means filter in which the filter strength h, which is one of the parameters used when weighting the neighboring pixel 44, is variable for each predetermined region 40.

### (Adaptive Non-Local Means Filter)

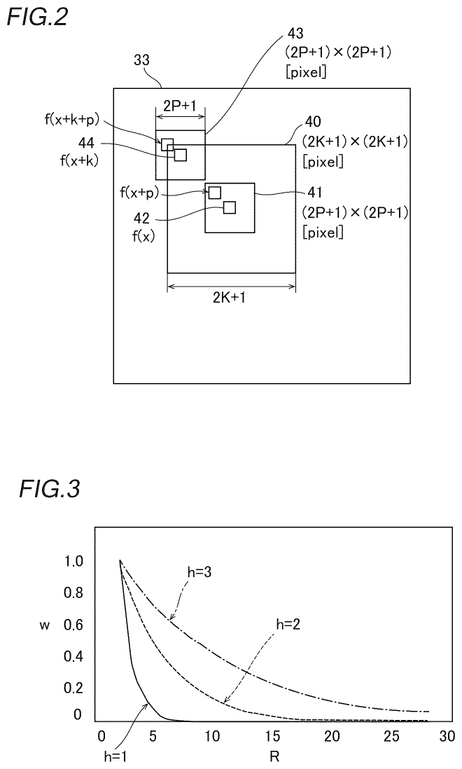

The smoothing process using the adaptive Non-Local Means filter will be described with reference to FIG. 2. The image processing unit 12 adjusts the filter strength h such that the filter strength h decreases as the acquired similarity index value increases, and performs a smoothing process on the image data by smoothing the target pixel 42 based on the adjusted filter strength hₒₚₜ, using the adaptive Non-Local Means filter.

In the smoothing process using the adaptive Non-Local Means filter, the image processing unit 12 acquires a Euclidean distance R of a patch region, which is a local region, in the predetermined region 40. The Euclidean distance R is an index for quantitatively evaluating the similarity of the patch regions. Then, a weight value w is assigned to the neighboring pixel 44 based on the acquired Euclidean distance R. Note that the Euclidean distance R is an example of the “similarity” in the claims.

The image processing unit 12 searches for a second region 43 (second patch region) including a neighboring pixel 44, which is similar to the first region 41 (first patch region) including the target pixel 42, within the predetermined region 40 of the tomographic image data 33. In the search for the second region 43, the image processing unit 12 acquires a Euclidean distance R for evaluating the similarity between the first region 41 including the target pixel 42 and the second region 43 including the neighboring pixel 44. The second region 43 is a region different from the first region 41, located in the vicinity of the target pixel 42, and including the neighboring pixel 44 included in the predetermined region 40.

The similarity between the first region 41 including the target pixel 42 and the second region 43 including the neighboring pixel 44 is quantified using the Euclidean distance R. As an example, the image processing unit 12 acquires the Euclidean distance R between the first region 41 including the target pixel 42 and the second region 43 different from the first region 41 including the neighboring pixel 44 located in the vicinity of the target pixel 42, the regions being included in the predetermined region 40 of the tomographic image data 33, using the following equation (3).

$$R [ x , k ] = \frac{1}{{( 2 P + 1 )}^{2}} {\sum }_{p ∈ {[ - P , P ]}^{2}} {( f [ x + k + p ] - f [ x + p ] )}^{2} \qquad ( 3 )$$

Here, R is the Euclidean distance for evaluating the similarity between the first region 41 and the second region 43 including the neighboring pixel 44, k is a position vector within the predetermined region 40, P is the patch region, and p is a position vector within the patch region.

That is, the image processing unit 12 compares the first region 41 and the second region 43, which are different regions (patch regions) within the predetermined region 40, and evaluates the Euclidean distance R. A smaller Euclidean distance R indicates that the regions (patch regions) are more similar to each other, and a larger Euclidean distance R indicates that the regions (patch regions) are less similar to each other.

Then, as an example, the image processing unit 12 acquires a weight value w of the neighboring pixel 44 included in the predetermined region 40, using the acquired Euclidean distance R, according to the following equation (4). Note that in the following equation (4), the standard deviation σ of noise is a predetermined reference value, and the filter strength h is a predetermined reference value.

$$w [ x , k ] = exp ( - \frac{max \{ R [ x , k ] - 2 {σ}^{2} , 0 \}}{{h}^{2}} ) \qquad ( 4 )$$

Here, w is the weight value of the neighboring pixel 44 included in the predetermined region 40, R is the Euclidean distance, k is a position vector within the predetermined region 40, σ is the standard deviation of noise in the image data, and h is the filter strength.

### (Relationship Between Negative Correlation of Euclidean Distance and Weight Value, and Filter Strength)

Here, the relationship between the negative correlation of the Euclidean distance R and the weight value w, and the filter strength h will be described with reference to FIG. 3 and the above equation (4).

FIG. 3 is a graph showing the weight value w calculated using the above equation (4) when the standard deviation σ of noise is a predetermined reference value (fixed value) and a changed filter strength h is used. In FIG. 3, a graph for “filter strength h=1”, a graph for “filter strength h=2”, and a graph for “filter strength h=3” are shown.

Further, the Euclidean distance R has a negative correlation with the weight value w. As the Euclidean distance R decreases, the weight value w increases. That is, a smaller Euclidean distance R indicates that the regions (patch regions) are more similar, so the more similar the regions (patch regions) are, the more the weight value w increases. Further, as the Euclidean distance R increases, the weight value w decreases. That is, a larger Euclidean distance R indicates that the regions (patch regions) are less similar, so the less similar the regions (patch regions) are, the more the weight value w decreases.

Further, h in the above equation (4) is a parameter related to the filter strength, and determines the bias of weighting with respect to the Euclidean distance R. The smaller the filter strength h, the stronger the bias is set, so weighting is performed by strictly determining the magnitude of the Euclidean distance R. For example, if it is determined from the magnitude of the Euclidean distance R acquired in the above equation (3) that the first region 41 and the second region 43 are not similar (Euclidean distance R is large), the weight value w is brought as close to zero as possible and the pixel is excluded from the pixels used for the smoothing process. If it is determined from the magnitude of the acquired Euclidean distance R that the first region 41 and the second region 43 are similar (Euclidean distance R is small), the weight value w is brought close to 1 and the pixel is included as a pixel used for the smoothing process. In other words, the filter strength h is a parameter related to the strictness of the evaluation of the Euclidean distance R.

As shown in FIG. 3, when the filter strength h is changed, the range in which the assignment of a low weight value w is maintained with respect to the Euclidean distance R changes. Specifically, the smaller the filter strength h, the longer the assignment of a low weight value w is maintained. The graph for filter strength h=1 maintains the assignment of a low weight value w in the direction where the Euclidean distance R becomes smaller, compared to the graphs for filter strength h=2 and filter strength h=3.

Further, when the filter strength h is changed, the steepness of the graph changes. Note that the steepness means the rate of change of the weight value w. Specifically, the smaller the filter strength h, the greater the steepness. In FIG. 3, the graph for filter strength h=1 has a greater steepness compared to the graphs for filter strength h=2 and filter strength h=3.

That is, in the above equation (4), the smaller the filter strength h, the more strictly the weight value w is calculated with respect to the change in the magnitude of the Euclidean distance R. In other words, the smaller the filter strength h, the larger the weight value w becomes only for those regions (patch regions) that are considerably similar (Euclidean distance R is small). On the other hand, in the above equation (4), the larger the filter strength h, the more gentle and uniform the weight value w becomes as a whole, and the weight value w is calculated like a moving average filter.

Returning to the description of the smoothing process using the adaptive Non-Local Means filter. Next, as an example, the image processing unit 12 acquires a similarity index value using the following equation (1). Specifically, the image processing unit 12 acquires the total sum wₜₒₜₐₗ of the weight values w of the neighboring pixels 44 in the predetermined region 40 as the similarity index value, using the following equation (1). That is, the total sum wₜₒₜₐₗ of the weight values w assigned to the neighboring pixels 44 within the predetermined region 40 shown in FIG. 2 is acquired. Note that the total sum wₜₒₜₐₗ of the weight values w is an example of the “similarity index value” in the claims.

$${w}_{total} [ x ] = {\sum }_{k ∈ {[ - K , K ]}^{2}} w [ x , k ] \qquad ( 1 )$$

Here, w is the weight value, and wₜₒₜₐₗ is the total sum of the weight values.

The total sum wₜₒₜₐₗ of the weight values w of the neighboring pixels 44 in the predetermined region 40 is an index for evaluating how many second regions 43 similar to the first region 41 exist around the first region 41 including the target pixel 42 in the predetermined region 40. The numerical range of the total sum wₜₒₜₐₗ of the weight values w is 0<wₜₒₜₐₗ<(2K+1)².

For example, when the total sum wₜₒₜₐₗ acquired by the above equation (1) is large (when wₜₒₜₐₗ≈(2K+1)²), it can be inferred that many of the weight values w of the neighboring pixels 44 acquired by the above equation (4) were acquired as 1. That is, when the total sum wₜₒₜₐₗ is large (when wₜₒₜₐₗ≈(2K+1)₂), it can be determined that there are many second regions 43 similar to the first region 41 around the first region 41 including the target pixel 42 in the predetermined region 40.

On the other hand, when the total sum wₜₒₜₐₗ of the weight values w as the similarity index value acquired by the above equation (1) is small (when wₜₒₜₐₗ≈0), it can be inferred that many of the weight values w of the neighboring pixels 44 acquired by the above equation (4) were acquired as 0. That is, when the total sum wₜₒₜₐₗ is small (when wₜₒₜₐₗ≈0), it can be determined that there are almost no second regions 43 similar to the first region 41 around the first region 41 including the target pixel 42 in the predetermined region 40.

Then, the image processing unit 12 adjusts the filter strength h of the predetermined region 40 based on the acquired similarity index value. Specifically, the image processing unit 12 adjusts the filter strength h of the predetermined region 40 such that the filter strength h of the predetermined region 40 becomes smaller than the reference value as the acquired total sum wₜₒₜₐₗ of the weight values w increases. Further, the image processing unit 12 adjusts the filter strength h of the predetermined region 40 such that the filter strength h approaches the reference value as the acquired total sum wₜₒₜₐₗ of the weight values w decreases. That is, the image processing unit 12 redefines the filter strength h, which is the reference value, according to the acquired total sum wₜₒₜₐₗ of the weight values w.

As an example, the image processing unit 12 adjusts the filter strength h of the predetermined region 40 such that the filter strength h of the predetermined region 40 becomes smaller than the reference value as the acquired total sum wₜₒₜₐₗ of the weight values w increases, using the following equation (2).

$${h}_{opt} [ x ] = h {\{ 1 - \frac{{w}_{total} [ x ]}{{( 2 K + 1 )}^{2}} \}}^{n} \qquad ( 2 )$$

Here, h is the reference value of the filter strength, hₒₚₜ is the adjusted filter strength, and wₜₒₜₐₗ is the total sum of the weight values.

The above equation (2) corrects (redefines) the filter strength h in inverse proportion to the magnitude of the acquired total sum wₜₒₜₐₗ of the weight values w. Note that n is an empirically determined power coefficient, and is for adjusting the response characteristics to changes in the total sum wₜₒₜₐₗ.

According to the adjustment of the filter strength h using the above equation (2), when it is estimated that there are many second regions 43 similar to the first region 41 around the first region 41 due to a large total sum wₜₒₜₐₗ of the weight values w, the filter strength h is adjusted to be smaller than the reference value. Therefore, as shown in the graph for “filter strength h=1” in FIG. 3, the range in which a low weight value w is maintained in the direction where the Euclidean distance R increases becomes longer. Therefore, in acquiring the weight value w of the neighboring pixel 44 using the adjusted filter strength hₒₚₜ described later, the weight value w is assigned more strictly to the acquired Euclidean distance R.

On the other hand, according to the adjustment of the filter strength h using the above equation (2), when it is estimated that there are almost no second regions 43 similar to the first region 41 around the first region 41 due to a small total sum wₜₒₜₐₗ of the weight values w, the filter strength h is adjusted to approach the reference value. That is, the adjusted filter strength hₒₚₜ becomes substantially the same value as the reference value.

Then, as an example, the image processing unit 12 re-acquires the weight value w of the neighboring pixel 44 included in the predetermined region 40, using the acquired Euclidean distance R and the filter strength hₒₚₜ adjusted by the above equation (2), according to the following equation (4). Note that in the following equation (4), the standard deviation σ of noise is a predetermined reference value, and the filter strength h is the filter strength hₒₚₜ adjusted by the above equation (2).

$$w [ x , k ] = exp ( - \frac{max \{ R [ x , k ] - 2 {σ}^{2} , 0 \}}{{h}^{2}} ) \qquad ( 4 )$$

Here, w is the weight value of the neighboring pixel 44 included in the predetermined region 40, R is the Euclidean distance, k is a position vector within the predetermined region 40, σ is the standard deviation of noise in the image data, and h is the filter strength (adjusted filter strength hₒₚₜ).

In the smoothing process using the adaptive Non-Local Means filter in the present embodiment, in the re-acquisition of the weight value w by equation (4) as an example, the same reference value is used for the standard deviation σ of noise for all target pixels 42 included in the tomographic image data 33, but the filter strength hₒₚₜ adjusted by the above equation (2) is used for each predetermined region 40 as the filter strength h.

Then, the image processing unit 12 performs a smoothing process on the tomographic image data 33 by smoothing the target pixel 42 based on the adjusted filter strength hₒₚₜ, using the adaptive Non-Local Means filter for each predetermined region 40. Specifically, the image processing unit 12 performs spatial filtering by convolution operation using the re-acquired weight value w of the neighboring pixel 44 included in the predetermined region 40. As an example, the image processing unit 12 performs spatial filtering by convolution operation using the re-acquired weight value w, according to the following equation (5).

$$g [ x ] = \frac{{\sum }_{k ∈ {[ - K , K ]}^{2}} w [ x , k ] f [ x + k ]}{{\sum }_{k ∈ {[ - K , K ]}^{2}} w [ x , k ]} \qquad ( 5 )$$

Here, g is the pixel value after the smoothing process, f is the pixel value before the smoothing process, k is a position vector within the predetermined region 40, and w is the weight value of the neighboring pixel 44 included in the predetermined region 40.

### (Comparison Between Smoothing Process Using Adaptive Non-Local Means Filter and Smoothing Process Using Non-Local Means Filter)

In the smoothing process using a conventional standard Non-Local Means filter, in acquiring the weight value w, the same reference value is used for the standard deviation σ of noise and the same reference value is used for the filter strength h for all target pixels 42 included in the tomographic image data 33. Therefore, when the predetermined region 40 is a low-contrast image region, excessive weighting may be applied to the entire low-contrast predetermined region 40. Due to this excessive weighting, in the image data after the smoothing process using the Non-Local Means filter, the subject 90 in the predetermined region 40 may be blurred or may have disappeared.

FIG. 5 is simulated image data 50. The simulated image data 50 includes a plurality of C-shaped portions with different contrasts. Further, the simulated image data 50 contains constant random noise throughout. The plurality of C-shaped portions are configured to have different contrasts. In FIG. 5, the C-shaped portion on the left side is displayed darkest, and the C-shaped portion on the right side is displayed lightest. That is, in FIG. 5, the C-shaped portion on the left side is an image of the highest-contrast C-shaped portion 50a, and the C-shaped portion on the right side is an image of the lowest-contrast C-shaped portion 50b.

FIG. 6 is simulated image data 51 obtained by performing a smoothing process on the simulated image data 50 of FIG. 5 using a conventional standard Non-Local Means filter. That is, it is the simulated image data 51 after the smoothing process by the above equations (3) to (5) has been performed on the simulated image data 50 of FIG. 5. As shown in FIG. 6, the low-contrast C-shaped portion 51b on the right side is blurred compared to the high-contrast C-shaped portion 51a on the left side. The reason why the low-contrast C-shaped portion 51b is blurred is that the low-contrast region as a whole is excessively weighted because the Euclidean distance R in the above equation (3) becomes small.

In the smoothing process using the adaptive Non-Local Means filter in the present embodiment, in the re-acquisition of the weight value w by equation (4) as an example, the same reference value is used for the standard deviation σ of noise for all target pixels 42 included in the tomographic image data 33, but the filter strength hₒₚₜ adjusted by the above equation (2) is used for each predetermined region 40 as the filter strength h. Therefore, in the tomographic image data 34 after the smoothing process using the adaptive Non-Local Means filter in the present embodiment, it is possible to suppress blurring or disappearance of the subject 90 in the predetermined region 40, compared to the tomographic image data 33 after the smoothing process using the Non-Local Means filter.

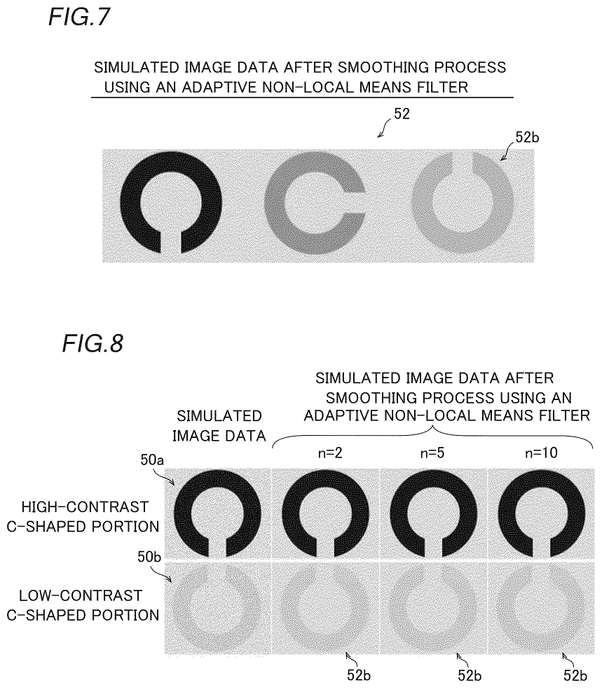

FIG. 7 is simulated image data 52 obtained by performing a smoothing process on the simulated image data 50 of FIG. 5 using the adaptive Non-Local Means filter according to the present embodiment. In the low-contrast C-shaped portion 52b on the right side shown in FIG. 7, blurring and disappearance of the C-shaped portion 52b in the predetermined region 40 are suppressed while noise is reduced, compared to the low-contrast C-shaped portion 51b on the right side shown in FIG. 6. Further, it can be seen that the edge of the low-contrast C-shaped portion 52b on the right side shown in FIG. 7 is sharper than the edge of the low-contrast C-shaped portion 51b on the right side shown in FIG. 6.

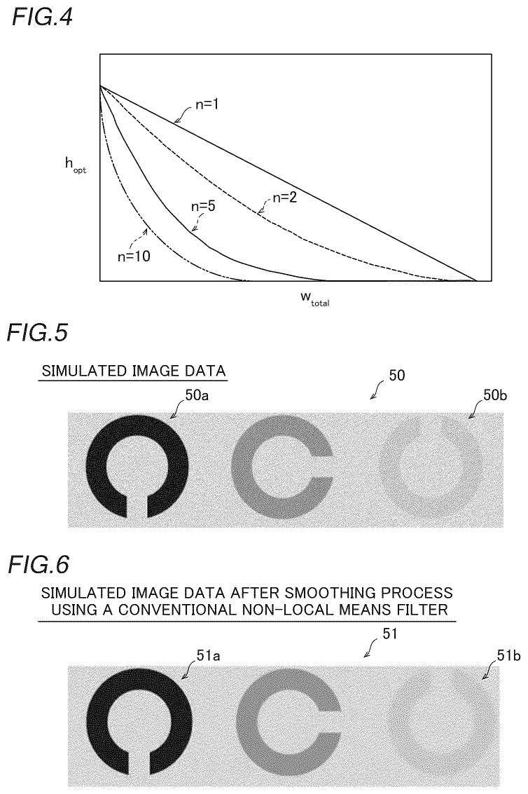

Further, FIG. 4 is a graph of the function of the above equation (2). As shown in FIG. 4, the filter strength hₒₚₜ is adjusted according to the magnitude of the total sum wₜₒₜₐₗ of the weight values w. Specifically, the larger the total sum wₜₒₜₐₗ of the weight values w, the smaller the adjusted filter strength hₒₚₜ. When the power coefficient n is increased, the steepness with respect to the total sum wₜₒₜₐₗ changes. Specifically, when the power coefficient n is large, the adjusted filter strength hₒₚₜ becomes small even if the total sum wₜₒₜₐₗ is not large, so the weight value w is assigned more strictly to the acquired Euclidean distance R. In this case, as shown in FIG. 8, noise remains slightly compared to the case where the power coefficient n is small.

### (Smoothing Process Using Adaptive Non-Local Means Filter by Image Processing Unit)

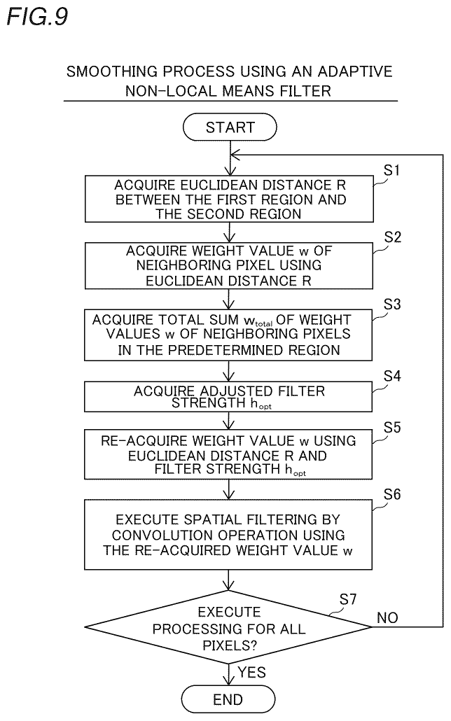

The smoothing process using the adaptive Non-Local Means filter by the image processing unit 12 according to the present embodiment will be described with reference to FIG. 9. The smoothing process using the adaptive Non-Local Means filter by the image processing unit 12 according to the present embodiment is started when the image processing unit 12 acquires the tomographic image data 33 before the smoothing process from the control device 20 via the image data transceiver unit 11. Note that the order of the processing steps can be interchanged or executed simultaneously as long as they do not contradict each other.

In step S1, the image processing unit 12 acquires the Euclidean distance R between the first region 41 including the target pixel 42 and the second region 43 different from the first region 41 including the neighboring pixel 44 located in the vicinity of the target pixel 42, the regions being included in the predetermined region 40 of the acquired tomographic image data 33, using the above equation (3). Thereafter, the process proceeds to step S2.

In step S2, the image processing unit 12 acquires the weight value w of the neighboring pixel 44 included in the predetermined region 40, using the acquired Euclidean distance R, according to the above equation (4). Thereafter, the process proceeds to step S3.

In step S3, the image processing unit 12 acquires the total sum wₜₒₜₐₗ of the weight values w of the neighboring pixels 44 in the predetermined region 40 as the similarity index value, using the above equation (1). That is, the total sum wₜₒₜₐₗ of the weight values w assigned to the neighboring pixels 44 within the predetermined region 40 is acquired. Thereafter, the process proceeds to step S4.

In step S4, the image processing unit 12 acquires the adjusted filter strength hₒₚₜ by adjusting the filter strength h of the predetermined region 40 such that the filter strength h of the predetermined region 40 becomes smaller than the reference value as the acquired total sum wₜₒₜₐₗ of the weight values w increases, using the above equation (2). Thereafter, the process proceeds to step S5.

In step S5, the image processing unit 12 re-acquires the weight value w of the neighboring pixel 44 included in the predetermined region 40, using the acquired Euclidean distance R and the filter strength hₒₚₜ adjusted by the above equation (2), according to the above equation (4). Thereafter, the process proceeds to step S6.

In step S6, the image processing unit 12 performs spatial filtering by convolution operation using the re-acquired weight value w, according to the above equation (5). Thereafter, the process proceeds to step S7.

In step S7, if the processing of steps S1 to S6 has been performed on all pixels in the acquired tomographic image data 33 (Yes in step S7), the process ends. If the processing of steps S1 to S6 has not been performed on all pixels in the acquired tomographic image data 33 (No in step S7), the process proceeds to step S1 to perform the smoothing process using the adaptive Non-Local Means filter on the pixels that have not been processed.

### Modifications

It should be understood that the embodiments and examples disclosed this time are illustrative in all respects and not restrictive. The scope of the present invention is indicated by the claims rather than the description of the embodiments and examples, and includes all modifications (variations) within the meaning and scope equivalent to the claims. For example, the image processing unit may be configured to acquire another index different from the total sum of the weight values of the neighboring pixels in the predetermined range as the similarity index value, and adjust the filter strength of the predetermined region based on the index different from the acquired total sum of the weight values.

Further, for example, the image processing unit may be configured to adjust the filter strength of the predetermined region such that when the total sum of the weight values as the similarity index value is smaller than a predetermined threshold, the filter strength of the predetermined region is set to a predetermined reference value.

Further, for example, in assigning the weight value to the neighboring pixel by the image processing unit, it is not always necessary to maintain the assignment of a low weight value as the filter strength decreases.

Further, for example, the image processing unit may be configured to acquire the total sum of the weight values of the neighboring pixels in the predetermined range as the similarity index value, using an equation different from the above equation (1).

Further, for example, as another example, the image processing unit may be configured to adjust the filter strength of the predetermined region such that the filter strength of the predetermined region becomes smaller than the reference value as the acquired total sum of the weight values increases, using the following equation (6).

$${h}_{opt} [ x ] = h cos ( \frac{π}{2} \frac{{w}_{b} [ x ]}{{( 2 K + 1 )}^{2}} ) \qquad ( 6 )$$

Here, h is the reference value of the filter strength, hₒₚₜ is the adjusted filter strength, and w_{b} is the total sum of the weight values.

Further, for example, the image data may be tomographic image data of a living body, various X-ray image data captured by simple X-ray imaging, fluoroscopic imaging, angiographic imaging, or the like, or image data other than X-ray image data. Further, for example, the image processing apparatus may be applied to an apparatus other than the X-ray imaging apparatus.

### Aspects

Those skilled in the art will understand that the exemplary embodiments described above are specific examples of the following aspects.

### (Item 1)

An image processing method comprising:
a step of acquiring a similarity between a first region including a target pixel and a second region different from the first region including a neighboring pixel located in the vicinity of the target pixel, the regions being included in a predetermined region of image data;
a step of acquiring a similarity index value as an index for evaluating a degree of abundance of the second region similar to the first region, based on the acquired similarity;
a step of adjusting a filter strength such that the filter strength, which indicates a degree of noise reduction in the predetermined region, decreases as the acquired similarity index value increases; and
a step of performing a smoothing process on the image data by smoothing the target pixel based on the adjusted filter strength, using an adaptive Non-Local Means filter capable of varying the filter strength for each predetermined region.

The filter strength is adjusted such that the filter strength of the predetermined region decreases as the acquired similarity index value increases. Here, when the acquired similarity index value is large, it may be that the predetermined region is a low-contrast image region because many second regions similar to the first region exist. Therefore, in the predetermined region which is a low-contrast image region with a large acquired similarity index value, the filter strength is adjusted to be small, and the target pixel is smoothed using the adaptive Non-Local Means filter based on the adjusted filter strength. Therefore, a different smoothing process can be performed for the high-contrast image region and the low-contrast image region. As a result, in the smoothing process of the image data, blurring and disappearance of the subject in the low-contrast image region of the image data can be suppressed.

### (Item 2)

The image processing method according to item 1, wherein the step of adjusting the filter strength adjusts the filter strength of the predetermined region such that the filter strength of the predetermined region approaches a predetermined reference value as the similarity index value decreases.

When the acquired similarity index value is small, it may be that the predetermined region is a high-contrast image region because there are few second regions similar to the first region. Therefore, in the predetermined region which is a high-contrast image region with a small acquired similarity index value, the filter strength is adjusted to approach the predetermined reference value, and the target pixel is smoothed using the adaptive Non-Local Means filter based on the filter strength substantially equal to the reference value. Therefore, noise in the image data can be reduced in the smoothing process of the image data.

### (Item 3)

The image processing method according to item 1 or 2, wherein
the step of acquiring the similarity index value acquires a total sum of weight values of the neighboring pixels in the predetermined region as the similarity index value, and
the step of adjusting the filter strength adjusts the filter strength of the predetermined region such that the filter strength of the predetermined region becomes smaller than a predetermined reference value as the acquired total sum of the weight values increases.

The total sum of the weight values of the neighboring pixels in the predetermined region can be used as an index for evaluating how many second regions similar to the first region exist around the first region including the target pixel in the predetermined region. That is, when the total sum of the weight values of the neighboring pixels in the predetermined region is large, it can be estimated that the predetermined region is a low-contrast image region where many second regions similar to the first region exist around the first region including the target pixel. Therefore, by adjusting the filter strength of the predetermined region such that the filter strength of the predetermined region becomes smaller than the reference value as the total sum of the weight values of the neighboring pixels in the predetermined region increases, the weight value can be assigned more strictly in the re-acquisition of the weight value of the neighboring pixel using the adjusted filter strength. Therefore, in the smoothing process of the image data, blurring and disappearance of the subject in the low-contrast image region of the image data can be appropriately suppressed.

### (Item 4)

The image processing method according to item 3, wherein the step of adjusting the filter strength adjusts the filter strength of the predetermined region such that the filter strength approaches the reference value as the acquired total sum of the weight values decreases.

When the total sum of the weight values of the neighboring pixels in the predetermined region is small, it can be estimated that the predetermined region is a high-contrast region where there are few second regions similar to the first region around the first region including the target pixel. Therefore, when the total sum of the weight values of the neighboring pixels in the predetermined region is small, the filter strength of the predetermined region is adjusted to approach the predetermined reference value. Therefore, for the predetermined region which is a high-contrast image region with a small total sum of weight values, the target pixel is smoothed using the adaptive Non-Local Means filter based on the filter strength substantially equal to the reference value. Therefore, noise in the image data can be appropriately reduced in the smoothing process of the image data.

### (Item 5)

The image processing method according to item 3 or 4, wherein the step of adjusting the filter strength maintains assignment of a low weight value as the filter strength decreases, in assigning the weight value to the neighboring pixel.

In this case, by maintaining the assignment of a low weight value as the filter strength decreases in assigning the weight value to the neighboring pixel, the weight value for the neighboring pixel of the second region can be increased only for the second region that is substantially the same as the first region. Therefore, the weight value for the neighboring pixel can be assigned more strictly compared to the case where the filter strength is large.

### (Item 6)

The image processing method according to any one of items 3 to 5, wherein the step of acquiring the similarity index value acquires the total sum of the weight values of the neighboring pixels in the predetermined region as the similarity index value, based on the following equation (1):

$${w}_{total} [ x ] = {\sum }_{k ∈ {[ - K , K ]}^{2}} w [ x , k ] \qquad ( 1 )$$

Here, w is the weight value, and wₜₒₜₐₗ is the total sum of the weight values.

In this case, since the total sum of the weight values of the neighboring pixels in the predetermined region is acquired as the similarity index value using the above equation (1), the total sum of the weight values of the neighboring pixels in the predetermined region can be easily acquired.

### (Item 7)

The image processing method according to any one of items 3 to 6, wherein the step of adjusting the filter strength adjusts the filter strength of the predetermined region such that the filter strength of the predetermined region becomes smaller than the reference value as the acquired total sum of the weight values increases, based on the following equation (2):

$${h}_{opt} [ x ] = h {\{ 1 - \frac{{w}_{total} [ x ]}{{( 2 K + 1 )}^{2}} \}}^{n} \qquad ( 2 )$$

Here, h is the reference value of the filter strength, hₒₚₜ is the adjusted filter strength, and wₜₒₜₐₗ is the total sum of the weight values.

In this case, since the filter strength of the predetermined region is adjusted such that the filter strength of the predetermined region becomes smaller than the reference value as the acquired total sum of the weight values increases, using the above equation (2), the adjusted filter strength can be easily acquired.

### (Item 8)

An image processing apparatus comprising:
an image data transceiver unit configured to transmit and receive image data; and
an image processing unit,
wherein the image processing unit
acquires a similarity between a first region including a target pixel and a second region different from the first region including a neighboring pixel located in the vicinity of the target pixel, the regions being included in a predetermined region of the image data acquired by the image data transceiver unit,
acquires a similarity index value as an index for evaluating a degree of abundance of the second region similar to the first region, based on the acquired similarity,
adjusts a filter strength such that the filter strength, which indicates a degree of noise reduction in the predetermined region, decreases as the acquired similarity index value increases, and
performs a smoothing process on the image data by smoothing the target pixel based on the adjusted filter strength, using an adaptive Non-Local Means filter capable of varying the filter strength for each predetermined region.

The filter strength is adjusted such that the filter strength of the predetermined region decreases as the acquired similarity index value increases. Here, when the acquired similarity index value is large, it may be that the predetermined region is a low-contrast image region because many second regions similar to the first region exist. Therefore, in the predetermined region which is a low-contrast image region with a large acquired similarity index value, the filter strength is adjusted to be small, and the target pixel is smoothed using the adaptive Non-Local Means filter based on the adjusted filter strength. Therefore, a different smoothing process can be performed for the high-contrast image region and the low-contrast image region. As a result, it is possible to provide an image processing apparatus capable of suppressing blurring and disappearance of the subject in the low-contrast image region of the image data in the smoothing process of the image data.

### REFERENCE SIGNS LIST

10 Image processing apparatus
11 Image data transceiver unit
12 Image processing unit
33 Tomographic image data before smoothing process (Image data)
40 Predetermined region
41 First region
42 Target pixel
43 Second region
44 Neighboring pixel
h Filter strength
hₒₚₜ Adjusted filter strength
R Euclidean distance (Similarity)
w Weight value
wₜₒₜₐₗ Total sum of weight values (Similarity index value)

1. An image processing method comprising:
a step of acquiring a similarity between a first region including a target pixel and a second region different from the first region including a neighboring pixel located in the vicinity of the target pixel, the regions being included in a predetermined region of image data;
a step of acquiring a similarity index value as an index for evaluating a degree of abundance of the second region similar to the first region, based on the acquired similarity;
a step of adjusting a filter strength such that the filter strength, which indicates a degree of noise reduction in the predetermined region, decreases as the acquired similarity index value increases; and
a step of performing a smoothing process on the image data by smoothing the target pixel based on the adjusted filter strength, using an adaptive Non-Local Means filter capable of varying the filter strength for each predetermined region.

2. The image processing method according to claim 1, wherein the step of adjusting the filter strength adjusts the filter strength of the predetermined region such that the filter strength of the predetermined region approaches a predetermined reference value as the similarity index value decreases.

3. The image processing method according to claim 1, wherein
the step of acquiring the similarity index value acquires a total sum of weight values of the neighboring pixels in the predetermined region as the similarity index value, and the step of adjusting the filter strength adjusts the filter strength of the predetermined region such that the filter strength of the predetermined region becomes smaller than a predetermined reference value as the acquired total sum of the weight values increases.

4. The image processing method according to claim 3, wherein the step of adjusting the filter strength adjusts the filter strength of the predetermined region such that the filter strength approaches the reference value as the acquired total sum of the weight values decreases.

5. The image processing method according to claim 3, wherein the step of adjusting the filter strength maintains assignment of a low weight value as the filter strength decreases, in assigning the weight value to the neighboring pixel.

6. The image processing method according to claim 3, wherein the step of acquiring the similarity index value acquires the total sum of the weight values of the neighboring pixels in the predetermined region as the similarity index value, based on the following equation (1):
$${w}_{total} [ x ] = {\sum }_{k ∈ {[ - K , K ]}^{2}} w [ x , k ] \qquad ( 1 )$$
Here, w is the weight value, and wₜₒₜₐₗ is the total sum of the weight values.

7. The image processing method according to claim 3, wherein the step of adjusting the filter strength adjusts the filter strength of the predetermined region such that the filter strength of the predetermined region becomes smaller than the reference value as the acquired total sum of the weight values increases, based on the following equation (2):
$${h}_{opt} [ x ] = h {\{ 1 - \frac{{w}_{total} [ x ]}{{( 2 K + 1 )}^{2}} \}}^{n} \qquad ( 2 )$$
Here, h is the reference value of the filter strength, hₒₚₜ is the adjusted filter strength, and wₜₒₜₐₗ is the total sum of the weight values.

8. An image processing apparatus comprising:
an image data transceiver unit configured to transmit and receive image data; and
an image processing unit,
wherein the image processing unit
acquires a similarity between a first region including a target pixel and a second region different from the first region including a neighboring pixel located in the vicinity of the target pixel, the regions being included in a predetermined region of the image data acquired by the image data transceiver unit,
acquires a similarity index value as an index for evaluating a degree of abundance of the second region similar to the first region, based on the acquired similarity,
adjusts a filter strength such that the filter strength, which indicates a degree of noise reduction in the predetermined region, decreases as the acquired similarity index value increases, and
performs a smoothing process on the image data by smoothing the target pixel based on the adjusted filter strength, using an adaptive Non-Local Means filter capable of varying the filter strength for each predetermined region.
